(19) United States
(12) Patent Application Publication
(10) Pub. No.: US 2019/0190874 A1
(43) Pub. Date: Jun. 20, 2019

(54) People Matching for Social Activities on an Online Social Network

(71) Applicant: Facebook, Inc., Menlo Park, CA (US)

(72) Inventors: Ashot Petrosian, Brooklyn, NY (US); William M. Ruben, San Francisco, CA (US)

(21) Appl. No.: 15/844,136

(22) Filed: Dec. 15, 2017

(51) Int. Cl. H04L 12/58; G06F 17/30

(52) U.S. Cl. CPC H04L 51/32; G06F 17/30241; G06F 17/3087; G06F 17/30867

(57) ABSTRACT

In one embodiment, a method includes identifying multiple users of an online social network based on one or more affinity coefficients between the users and a geographical location associated with each of the users and sending a message corresponding to an activity recommendation to each of the users. The method also includes receiving one or more responses to the message from one or more users of the multiple users, respectively, where each response indicates whether the respective user is interested in the recommended activity. The method further includes, if the response from each of at least two of the users indicates an interest in the recommended activity, then sending a notification to each of the users who indicated an interest in the recommended activity identifying the other users who also indicated an interest in the recommended activity. Otherwise, the method includes deactivating the activity recommendation.

### TECHNICAL FIELD

This disclosure generally relates to promoting social activities using an online social network.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

In particular embodiments, the social-networking system may facilitate user engagement in real-world social activities by sending users targeted and private “icebreaker” messages and soliciting the user's interest using a double opt-in flow for confirming interest in the social activities. Nowadays, as membership in traditional community institutions declines, so does spending time with people who have common interests through these organizations. The number of people one is connected to and interacts with in the digital world has grown immensely, but it is often the case that one still socializes with relatively few people in real life. At the same time, the stigma around meeting people online is rapidly fading, and more people are open to new ways of meeting others. One primary friction preventing real-world connections is the risk of rejection involved in initiating a social activity. Before two people spend time with each other, one of them must take the initiative to ask others about a particular social activity (e.g., by sending a message), thus risking rejection or awkward communications. Furthermore, there may be a burden of leadership that prevents interest-based activities from occurring and interest groups forming. The task of coalescing a critical mass of individuals for a social activity to occur is often daunting and may be a major deterrence to people. As a result, while there may be significant mutual interest among people to socialize with each other, none of them may be willing to take the initiative or to make the effort to make a plan and organize a social activity. Particular embodiments disclosed herein allow the social-networking system to function as a “matchmaker” for social activities that removes the risk of rejection faced by the users and reduces the burden of planning and coordinating. Particular embodiments disclosed herein may provide a location-based service that is highly customizable to individual users and that exploits data gathered from a plurality of client systems, the computing capabilities of server systems, as well as structured data stored in association with an online social network. The service may employ artificial-intelligence, machine-learning, or other suitable techniques and intelligently grant or restrict user access to particular information using one or more information generating or filtering processes. The service may also offer novel user-interface features that enhance the clarity of displayed social-activity information, facilitate decision-making as to activity recommendations, and save user effort in responding to join or dismiss social activities.

In particular embodiments, the social-networking system may identify two or more users who are likely to be interested in hanging out with each other and send each of the users a message querying the user's interest in connecting with the other users. The message may be related to a particular activity recommendation and specify time, location, or other details about the recommended activity. As an example and not by way of limitation, the social-networking system may send Jack a message, “Want to hang out with Jill this week?” As another example and not by way of limitation, the social-networking system may send a more specific message, such as “Want to watch the Giants (a professional baseball team) game with Jill on Friday?” The social-networking system may receive one or more responses from one or more of the users indicating whether each user is interested in the recommended activity. When at least a particular number of the users indicate an interested in the recommended activity (e.g., at least two users, all users, etc.), the social-networking system may notify each of the interested users their common interest. As an example and not by way of limitation, if Jack and Jill both indicate an interest in watching the Giants game, the social-networking system may send each of them a notification suggesting them to hang out. The social-networking system may also directly put both Jack and Jill on a message thread to coordinate (for example, by switching context from a social-networking application to a messaging application). On the other hand, if there are not enough users who are interested, the social-networking system may keep each user's response private. In this way, the social-networking system may leverage its access to user data, its data analysis capabilities, and its platform for users to connect and communicate with each other to facilitate user participation in real-world social activities.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example user interface displaying a notification of pending activity recommendations.

FIGS. 2A-2B illustrate an example user interface displaying a list of messages corresponding to activity recommendations.

FIGS. 3A-3B illustrate example user interfaces displaying detailed views of messages corresponding to activity recommendations.

FIG. 4 illustrates an example method for facilitating user engagement in social activities through targeted and private messaging and a double opt-in flow.

FIG. 5 illustrates an example network environment associated with a social-networking system.

FIG. 6 illustrates an example social graph.

FIG. 7 illustrates an example computer system.

### DESCRIPTION OF EXAMPLE EMBODIMENTS

### People Matching for Social Activities

In particular embodiments, the social-networking system may facilitate user engagement in real-world social activities by sending users targeted and private “icebreaker” messages and soliciting the user's interest using a double opt-in flow for confirming interest in the social activities. Nowadays, as membership in traditional community institutions declines, so does spending time with people who have common interests through these organizations. The number of people one is connected to and interacts with in the digital world has grown immensely, but it is often the case that one still socializes with relatively few people in real life. At the same time, the stigma around meeting people online is rapidly fading, and more people are open to new ways of meeting others. One primary friction preventing real-world connections is the risk of rejection involved in initiating a social activity. Before two people spend time with each other, one of them must take the initiative to ask others about a particular social activity (e.g., by sending a message), thus risking rejection or awkward communications. Furthermore, there may be a burden of leadership that prevents interest-based activities from occurring and interest groups forming. The task of coalescing a critical mass of individuals for a social activity to occur is often daunting and may be a major deterrence to people. As a result, while there may be significant mutual interest among people to socialize with each other, none of them may be willing to take the initiative or to make the effort to make a plan and organize a social activity. Particular embodiments disclosed herein allow the social-networking system to function as a “matchmaker” for social activities that removes the risk of rejection faced by the users and reduces the burden of planning and coordinating. Particular embodiments disclosed herein may provide a location-based service that is highly customizable to individual users and that exploits data gathered from a plurality of client systems, the computing capabilities of server systems, as well as structured data stored in association with an online social network. The service may employ artificial-intelligence, machine-learning, or other suitable techniques and intelligently grant or restrict user access to particular information using one or more information generating or filtering processes. The service may also offer novel user-interface features that enhance the clarity of displayed social-activity information, facilitate decision-making as to activity recommendations, and save user effort in responding to join or dismiss social activities.

In particular embodiments, the social-networking system may identify two or more users who are likely to be interested in hanging out with each other and send each of the users a message querying the user's interest in connecting with the other users. The message may be related to a particular activity recommendation and specify time, location, or other details about the recommended activity. As an example and not by way of limitation, the social-networking system may send Jack a message, “Want to hang out with Jill this week?” As another example and not by way of limitation, the social-networking system may send a more specific message, such as “Want to watch the Giants (a professional baseball team) game with Jill on Friday?” The social-networking system may receive one or more responses from one or more of the users indicating whether each user is interested in the recommended activity. When at least a particular number of the users indicate an interested in the recommended activity (e.g., at least two users, all users, etc.), the social-networking system may notify each of the interested users their common interest. As an example and not by way of limitation, if Jack and Jill both indicate an interest in watching the Giants game, the social-networking system may send each of them a notification suggesting them to hang out. The social-networking system may also directly put both Jack and Jill on a message thread to coordinate (for example, by switching context from a social-networking application to a messaging application). On the other hand, if there are not enough users who are interested, the social-networking system may keep each user's response private. In this way, the social-networking system may leverage its access to user data, its data analysis capabilities, and its platform for users to connect and communicate with each other to facilitate user participation in real-world social activities.

In particular embodiments, the social-networking system may identify a plurality of users of the online social network who are likely to be interested in hanging out with each other. The users may be identified based at least in part on one or more affinity coefficients between the users. The users may additionally or alternatively be identified based at least in part on a geographical location associated with each of the users. In particular embodiments, the social-networking system may identify the plurality of users based on one or more suitable factors other than the affinity coefficients and geographical locations. The use of user information in the identification process may be subject to one or more privacy settings of the users.

In particular embodiments, the social-networking system may identify the users based at least in part on proximity among one or more of the geographical locations associated with one or more of the users, respectively. The consideration of geographical proximity may serve to make any activity recommended by the social-networking system convenient for the users. Alternatively, the social-networking system may identify one or more users who are not in geographical proximity with each other and suggest the users to travel to participate in a recommended activity.

In particular embodiments, an affinity coefficient between any two users may quantify the strength of a relationship or level of interest between the users. The affinity coefficient between a given pair of users may be calculated based at least in part on a variety of factors including, for example, a degree of separation between the users in a social graph of the online social network, a commonality between the users (e.g., hometown, education, interest), a social-interaction history between the users, demographic information of the users, other suitable factors, or any combination thereof. The social-networking system may determine that two users having a high affinity coefficient are likely to have a strong relationship and are likely to be interested in hanging out with each other.

As an example and not by way of limitation, the social-networking system may identify a user John, who lives in Palo Alto, Calif., and a user Jane, who lives in Menlo Park, Calif., which is a city adjacent to Palo Alto. The social-networking system may determine that John and Jane are in geographical proximity with each other as Palo Alto and Menlo Park are neighboring cities. It may further determine that John and Jane have a high affinity coefficient with each other as they are friends on the online social network and interact frequently thereon. The social-networking system may conclude that John and Jane are likely to be interested in hanging out with each other and, accordingly, send an icebreaker message (i.e., a message corresponding to an activity recommendation) to each of them recommending a social activity with the other.

In particular embodiments, each of the identified users may be within a particular degree of separation within a social graph of the online social network from each of the other identified users. This may allow the social-networking system to shape the nature of the recommended event. In particular embodiments, the identified users may be first-degree contacts (e.g., friends) of each other, first- or second-degree contacts (e.g., friends of friends) of each other, or second- or higher-degree contacts of each other (e.g., strangers) on the online social network. For a particular user, the different degree-of-separation scenarios may correspond to, for example, hangouts with close friends (e.g., first-degree contacts only), party within the user's general social circle (e.g., first- or second-degree contacts only), mixers with non-friends who have mutual friends or common interests (e.g., second-degree contacts only), blind dates (e.g., second- or third-degree contacts only), etc.

In particular embodiments, the social-networking system may identify the plurality of users further based on one or more selection rules. The selection rules may take into account information about one or more prior messages corresponding to activity recommendations sent by the social-networking system. As an example and not by way of limitation, at least one of the selection rules may specify that identifying one or more of the users is based on a condition that the one or more of the users are not identified for a different activity recommendation within a specified time period. For example, if the social-networking system identified a first user and a second user and sent them an icebreaker message recommending a social activity, the social-networking system may refrain from sending both users another icebreaker message within, for example, a month thereafter. As another example and not by way of limitation, after one or more users who are first-degree contacts with each other all indicate an interest in a particular recommended activity and participated in the activity, the social-networking system may identify each of the interested users and one or more other users who are a first-degree contact with at least one but not all of the interested users for a follow-up activity. Although this disclosure describes identifying particular users in a particular manner, this disclosure contemplates identifying any suitable users in any suitable manner.

In particular embodiments, the social-networking system may send a message corresponding to an activity recommendation to each of the identified users. The message may comprise identification information of one or more of the other users of the plurality of users and a prompt for a response from the receiving user indicating whether the receiving user is interested in the recommended activity. The prompt for response may be in the form of an icebreaker question (i.e., a question asking whether the receiving user is interested in engaging in the recommended activity with the other users). As an example and not by way of limitation, after identifying users John and Jane as likely to be interested in hanging out with each other, the social-networking system may send John a message comprising the icebreaker question “Want to hang out with Jane this week?” and send Jane a message comprising the icebreaker question “Want to hang out with John this week?”

In particular embodiments, the activity recommendation sent by the social-networking system may contain a range of amount of details. The message may comprise one or more of a time period associated with the activity recommendation, a geographical location associated with the activity recommendation, a description of the recommended activity, other suitable details, or any combinations thereof. As an example and not by way of limitation, an icebreaker message sent to Jane may broadly suggest her to chat or connect with John in the next month, may specifically suggest her to get lunch with John this weekend, or to suggest her to have coffee with John at exactly 3 p.m. this Sunday at Starbucks.

In particular embodiments, the social-networking system may generate the activity recommendation based on a common interest associated with one or more of the identified users. The common interest may be determined based on one or more user profiles associated with the one or more of the identified users, respectively. As an example and not by way of limitation, the social-networking system may access profile information of both John and Jane and determine that both of them are fans of the Seattle Seahawks (a professional football club). The social-networking system may customize an icebreaker message sent to each of John and Jane and ask them to watch a Seattle Seahawks game together.

In particular embodiments, a social graph associated with the social-networking system may comprise a plurality of nodes and a plurality of edges connecting the nodes. Each of the edges between two of the nodes may represent a single degree of separation between them. The nodes may comprise a plurality of first nodes corresponding to the plurality of identified users and a plurality of second nodes corresponding to a plurality of objects associated with the online social network, respectively. The message corresponding to the activity recommendation sent by the social-networking system may further comprise a reference to an object of the plurality of objects, the object being associated with the activity recommendation. The second node corresponding to the referenced object may be connected to one or more of the first nodes by one or more of the edges, respectively. The reference to objects associated with the online social network may be subject to one or more of the users' privacy settings regarding their connections to other users or objects. As an example and not by way of limitation, the social-networking system may identify the users John and Jane and access their respective nodes in the social graph. The social-networking system may determine that each of the nodes is connected to a node representing the object Stanford University by an edge, as both users are students of Stanford University. Based on this determination, the social-networking system may send John and Jane a message including a recommendation that they go to an on-campus concert, the message referring to the object Stanford University.

In particular embodiments, the social-networking system may generate the activity recommendation based on one or more prior activities associated with one or more users of the plurality of users, one or more responses to one or more prior messages corresponding to activity recommendations received from one or more users of the plurality of users, one or more upcoming events associated with one or more users of the plurality of users, other suitable factors, or any combination thereof. The social-networking system may record a user's prior responses to icebreaker questions and history of participating in social activities suggested by the social-networking system. Based on such information, the social-networking system may determine the user's interest in a future activity with another user. As an example and not by way of limitation, the social-networking system may access a picture posted by John tagging John, Jane, Jack, and Jill at a football game. The social-networking system may generate an activity recommendation for the four users to go to a future football game based on this prior activity associated with the users. As another example and not by way of limitation, the social-networking system may have previously sent Mary and Mike a message including a recommendation to attend a wine-tasting event. Neither Mary nor Mike responded to the message. The social-networking system may have also sent Mary and Mike a message including a recommendation to attend a beer-tasting event. Both responded to indicate their interest. The social-networking system may thereby determine that Mary and Mike are more interested in beer than in wine and send them an icebreaker question soliciting their interest as to dinner at a local brewery. As yet another example and not by way of limitation, the social-networking system may determine that both Adam and Bob have signed up for a musical show. It may further determine that their homes are five-minute-drive away from each other and are both two-hour-drive away from the theatre. The social-networking system may generate a recommendation that Adam and Bob carpool to the show and send a corresponding message to each of them.

In particular embodiments, the social-networking system may use an activity-recommendation process. Sending each icebreaker message corresponding to an activity recommendation may be performed as part of the activity-recommendation process of the online social network. The activity-recommendation process may send messages corresponding to activity recommendations at a pre-determined frequency. The frequency may be automatically determined by the social-networking system or be specified by a particular user of the online social network. As an example and not by way of limitation, a user John may receive a plurality of messages from the social-networking system recommending activities with a plurality of other users as part of the activity-recommendation process. The social-networking system may originally send John one message per day. John may be willing to see more options and may change his frequency settings to specify this preference. Based on John's frequency settings, the social-networking system may begin to send John five such icebreaker messages per day. The activity-recommendation process may also track and record a user's responses to messages corresponding to activity recommends. User-specific traits and preferences may be derived from the user's response history.

In particular embodiments, each activity recommendation may be associated with an expiry date. The social-networking system may deactivate the activity recommendation when the expiry date has passed. As an example and not by way of limitation, the social-networking system may send each of John and Jane a message recommending them to hang out during the upcoming weekend. The social-networking system may set the expiry date for the message to be the Sunday of the specified weekend. If Sunday has passed and neither John nor Jane has responded to the message, the social-networking system may deactivate this activity recommendation. Although this disclosure describes sending particular messages corresponding to particular activity recommendations to particular users in a particular manner, this disclosure contemplates sending any suitable communication to any suitable users in any suitable manner.

In particular embodiments, the social-networking system may receive one or more responses to the message from one or more users of the plurality of users, respectively. Each response may indicate whether the respective user is interested in hanging out with the other users identified in the message or in the recommended activity. As an example and not by way of limitation, after sending each of John and Jane a message recommending them to hang out in the upcoming weekend, the social-networking system may receive a “Yes” response from each of the users indicating an interested in the recommended activity. Although this disclosure describes receiving particular responses from particular users in a particular manner, this disclosure contemplates receiving any suitable communications from any suitable users in any suitable manner.

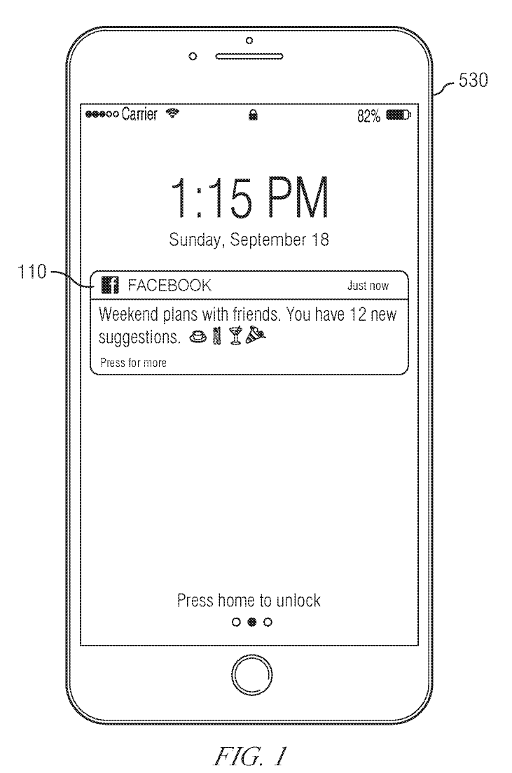

FIG. 1 illustrates an example user interface displaying a notification of pending activity recommendations. In particular embodiments, the social-networking system may send a notification 110 associated with icebreaker messages to a client system 530 associated with a user for display. The notification 110 may be a push notification by an application associated with the social-networking system or another suitable type of notification. It may be displayed in a lock-screen user interface. The notification 110 may indicate to the user that messages corresponding to activity recommendations are pending and provide a count of such messages. The user may interact with the notification 110 to open the application associated with the social-networking system and access the messages. Although FIG. 1 illustrates a particular user interface displaying a particular notification in a particular manner, this disclosure contemplates any suitable user interface displaying any suitable notification in any suitable manner.

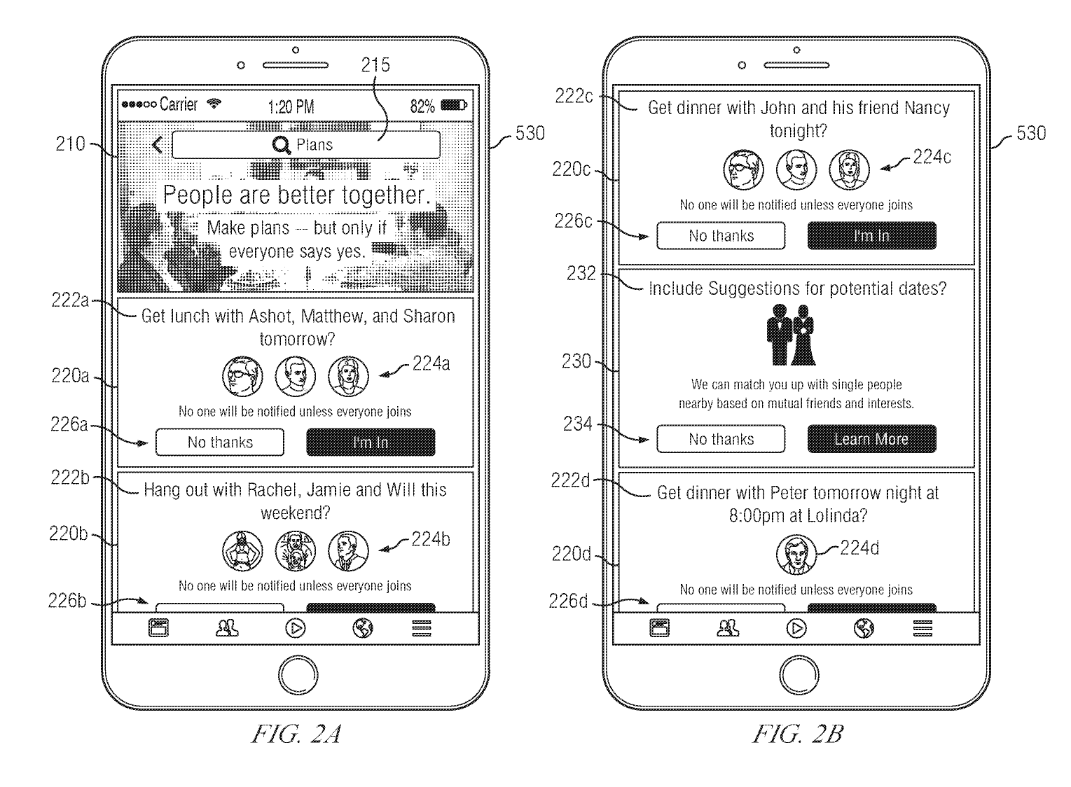

FIGS. 2A-2B illustrate an example user interface displaying a list of messages corresponding to activity recommendations. In particular embodiments, the social-networking system may provide for display a user interface 210 comprising one or more icebreaker messages for a particular user. The user interface 210 may be displayed within an application associated with social-networking system, within a web browser, or within another suitable application. The user interface 210 may comprise icebreaker messages 220. Each of the icebreaker messages 220 may correspond to an activity recommendation generated by the social-networking system. In particular embodiments, each icebreaker message 220 may comprise a text section 222 identifying one or more other users and describing a recommended activity. Each icebreaker message 220 may also comprise one or more profile pictures 224 associated with the identified users. Each icebreaker message 220 may further comprise one or more interactive elements 226 allowing the user to input a response. As an example and not by way of limitation, the user may click or tap on the “I'm In” button to indicate an interest in the recommended activity. The user may click or tap on the “No thanks” button to indicate a lack of interest, upon which the corresponding icebreaker message 220 may be dismissed and removed from the user interface 210. The user interface 210 may comprise a search field 215 allowing a user to search for one or more of the icebreaker messages 220 by entering a text string. The user interface 210 may further comprise a message 230 that includes a question 232 asking if the user is interested in a new type of icebreaker messages (e.g., potential dates). The user may interact with interactive elements 234 to indicate an interest (e.g., “Learn More”) or a lack of interest (e.g., “No Thanks”). If the user indicates an interest, the social-networking system may proceed to provide one or more icebreaker messages recommending dates with strangers.

In particular embodiments, the activity recommendations provided by the social-networking system may contain different levels of details. As an example and not by way of limitation, the icebreaker message 220a may specify in section 222a a specific activity (i.e., get lunch) and a specific day (i.e., tomorrow). As another example and not by way of limitation, the icebreaker message 220b may only comprise a high level question 222b (“Hang out with Rachel, Jamie, and Will this weekend?”). As yet another example and not by way of limitation, the icebreaker message 220d may provide specific details in section 222d, including a specific activity (i.e., get dinner), a specific time (tomorrow night at 8:00 pm), and a specific location (e.g., Lolinda). In particular embodiments, the social-networking system may recommend social activities associated with other users having different degrees of separation from the user. As an example and not by way of limitation, the icebreaker message 220d recommends an activity with a first-degree contact Peter. As another example and not by way of limitation, the icebreaker message 220c recommends an activity with a first-degree contact John and a second-degree contact Nancy. Although FIGS. 2A-2B illustrate a particular user interface displaying particular messages in a particular manner, this disclosure contemplates any suitable user interface displaying any suitable messages in any suitable manner.

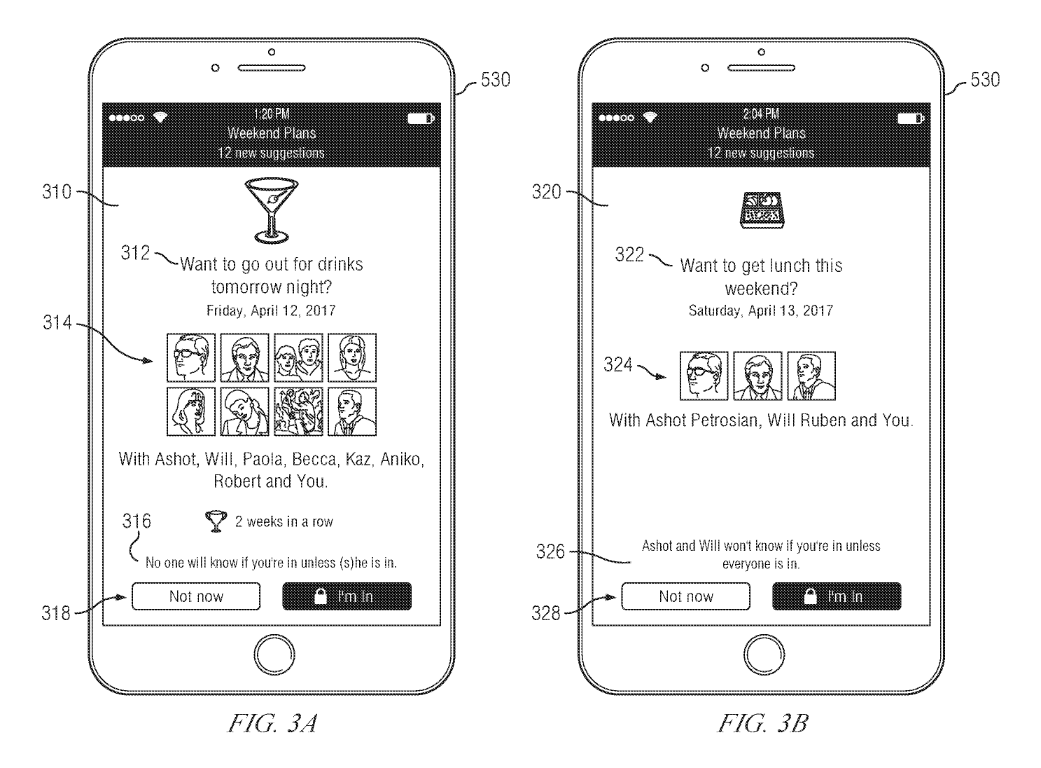

FIGS. 3A-3B illustrate example user interfaces displaying detailed views of messages corresponding to activity recommendations. In particular embodiments, the social-networking system may provide a detailed view for each icebreaker message. The user may access the detailed view by, for example, tapping on an icebreaker message 220 in the user interface 210. As illustrated by FIG. 3A, the detailed view 310 may comprise an icebreaker question 312 (“Want to go out for drinks tomorrow night?”), identification information for one or more other identified users 314, and a text string 316 explaining a privacy status of the message 310. For example, the text string may explain that “[n]o one will know if you're in unless (s)he is in.” The detailed view 310 may further comprise interactive elements 318 allowing the user to respond.

Similarly, the detailed view 320 may comprise an icebreaker question 322 (“Want to get lunch this weekend?”), identification information for one or more other identified users 324, and a text string 326 explaining a privacy status of the message 320. The privacy status for the message 320 may be different from that for the message 310. For example, each of the users identified in the message 320 may get informed about whether each other user is interested in the event only if everyone is in. The detailed view 320 may further comprise interactive elements 328 allowing the user to respond. Although FIGS. 3A-3B illustrate particular views of particular messages displayed in a particular manner, this disclosure contemplates any suitable views of any suitable messages displayed in any suitable manner.

In particular embodiments, the social-networking system may take one or more follow-up steps according to a double opt-in flow responsive to receiving one or more responses from the users. The social-networking system may require a threshold number (e.g., two, five, ten) of positive responses to an icebreaker question before notifying any user of other user's interest. As an example and not by way of limitation, if the response from each of at least two of the users indicates an interest in a recommended activity, then the social-networking system may send a notification to each of the users who indicated an interest in the recommended activity identifying the other users who also indicated an interest in the recommended activity. Alternatively, the social-networking system may require a positive response from each of the users who received the icebreaker message in order to notify any of the users. If the social-networking system fails to receive the threshold number of positive responses from the users within a particular timeframe, it may refrain from notifying any user about the decisions of other users and deactivate the activity recommendation. The social-networking system may deactivate the activity recommendation immediately after it receives a certain number of rejections of the activity recommendation or when an expiry date associated with activity recommendation passes without receiving a sufficient number of positive responses. In this manner, a user's interest in a particular activity is only revealed to a number of other users who also indicate their interest. This protects each user's privacy and removes the risk of rejection that a user would normally face in initiating a social activity.

In particular embodiments, the social-networking system may send the notification to each of the users who indicated an interest in the recommended activity identifying the other users who also indicated an interest in the recommended activity in one or more different manners. As an example and not by way of limitation, the social-networking system may initiate a message thread including each of the users who indicated an interest in the recommended activity, on which the users may communicate to coordinate the activity. As another example and not by way of limitation, the social-networking system may send each user a push notification, a direct message, a wall post, an email, an SMS message, another suitable type of communication, or any combination thereof. As yet another example and not by way of limitation, the social-networking system may generate an event object on the online social network with the users who indicated an interest in the recommended activity as invitees. The event object may comprise information associated with the activity recommendation; such information may be modifiable by the invited users.

As an example and not by way of limitation, the social-networking system may send each of users John, Jane, Jack, and Jill an icebreaker message comprising an activity recommendation to hang out with the other three users. In one scenario, the four users may each respond to indicate an interest in the recommended activity. The social-networking system may accordingly initiate a message thread including all four users for them to coordinate the activity. In another scenario, John may respond to the icebreaker message indicating an interest in the recommended activity. Jane and Jack may respond to reject the activity recommendation. Jill may not respond to the icebreaker message within a pre-determined one-week time limitation for it. In this case, the social-networking system may deactivate the activity recommendation without notifying any of the users about other users' responses. Although this disclosure describes sending particular notifications to particular users in a particular manner, this disclosure contemplates sending any suitable communications to any suitable users in any suitable manner.

In particular embodiments, the social-networking system may identify a group of users for an activity recommendation using an iterative process. The social-networking system may first send an icebreaker message to a plurality of first users and receive a response from each of at least two of the first users indicating an interest in the recommended activity. The social-networking system may identify one or more second users of the online social network based on social-networking information associated with the at least two of the first users. The identified second users may be social contacts of the at least two of the first users. The social-networking system may then send the message corresponding to the activity recommendation to each of the second users and receive one or more responses to the message from one or more second users, respectively, each response indicating that the respective second user is interested in the recommended activity. The social-networking system may send an additional notification to each of the users (including first users and second users) who indicated an interest in the recommended activity identifying the other users who also indicated an interest in the recommended activity.

As an example and not by way of limitation, the social-networking system may identify a group of first users who are likely to be interested in an event and send an icebreaker question to each of the first users. For example, the social-networking system may send a message to each member of an outdoor recreation club recommending a hiking trip in the Rocky Mountains. The social-networking system may receive responses from two of the first users John and Jane indicating an interest in the recommended activity. Based on the responses, the social-networking system may identify one or more second users based on social-networking information associated with John and Jane. The second users may not be in the original group of users, but may be social connections of the two first users. For example, the social-networking system may identify Mary and Mike, who are not members of the outdoor recreation club, but are both first-degree friends of John and Jane and both live in the Rocky Mountain area. The social-networking system may also determine that the two first users, John and Jane, and the two second users, Mary and Mike, are likely to be interested in hanging out with each other. The social-networking system may then send updated icebreaker messages to each of the four users to verify their interests.

In particular embodiments, the social-networking system may identify, for a particular user, one or more other users that the particular user is interested in hanging out with based on relevant historical records. For a first user, the social-networking system may record one or more responses by the first user to one or more prior messages corresponding to activity recommendations and identify one or more second users identified in the prior messages. Based on the recorded responses, the social-networking system may compile a list of users of interest to the first user, the list comprising one or more of the second users. The list of users may comprise one or more close friends of the first user, with whom the first user would like to frequently socialize. The social-networking system may accordingly recommend future activities involving the first user and other users on the first user's list.

In particular embodiments, the social-networking system may allow a user to affirmatively provide a list of other users of interest. The social-networking system may store this list received from the user and repetitively provide icebreaker messages involving the user providing the list and the listed users suggesting different times, locations, and activities. In particular embodiments, the plurality of users identified for a particular activity recommendation may comprise a first user and one or more second users identified in a list of users of interest to the first user received from the first user.

In particular embodiments, the social-networking system may provide icebreaker questions in a privacy-aware manner. It may access privacy settings of the users to make sure that icebreaker questions do not reveal facts (e.g., geographical location, school, friend list) that are not visible (i.e., non-public or inaccessible) to particular users. In particular embodiments, for each user of the plurality of identified users, the social-networking system may access one or more privacy settings associated with the user and determining, based on the privacy settings and prior to sending the icebreaker message, that the geographical location of the user is visible to each of the other users of the plurality of users. As an example and not by way of limitation, a profile of a user John on the online social network may indicate that he currently lives in San Francisco. John may have marked such location information private or invisible to anyone but himself. Based on John's privacy settings, the social-networking system may refrain from including John in an icebreaker message recommending a local activity in San Francisco because one or more other users may infer that John lives in San Francisco based on the message.

In particular embodiments, for each user of the plurality of identified users, the social-networking system may access one or more privacy settings associated with the user and verifying, based on the privacy settings and prior to sending the message, that information associated with the user in the message is visible to each of the other users of the plurality of users. As an example and not by way of limitation, a user Jane may make information about her education history, including her alma mater Stanford University, private. In this case, the social-networking system may refrain from sending Jane an icebreaker message recommending her to attend an alumni event of Stanford University to avoid disclosing Jane's education information to another user. As another example and not by way of limitation, if a user Jack's privacy settings make his friend relationship with another user Jill private, the social-networking system may refrain from sending an icebreaker message to James suggesting him to hang out with Jack and Jill. This is because James may figure out that Jack and Jill are friends on the online social network based on the message.

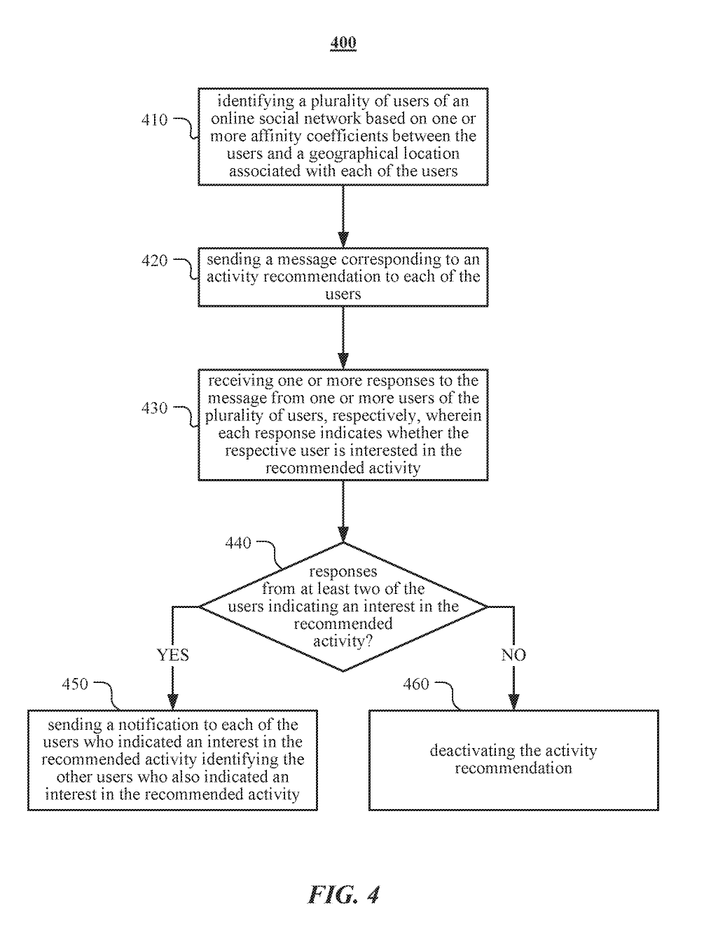

FIG. 4 illustrates an example method 400 for facilitating user engagement in social activities through targeted and private messaging and a double opt-in flow. The method may begin at step 410, where a social-networking system may identify a plurality of users of an online social network based on one or more affinity coefficients between the users and a geographical location associated with each of the users. At step 420, the social-networking system may send a message corresponding to an activity recommendation to each of the users. The message may comprise identification information of one or more of the other users of the plurality of users and a prompt for a response from the receiving user indicating whether the receiving user is interested in the recommended activity. At step 430, the social-networking system may receive one or more responses to the message from one or more users of the plurality of users, respectively. Each response indicates whether the respective user is interested in the recommended activity. At step 440, the social-networking system may determine if it has received responses from at least two of the users, each indicating an interest in the recommended activity. If so, the social-networking system may proceed to step 450 and send a notification to each of the users who indicated an interest in the recommended activity identifying the other users who also indicated an interest in the recommended activity. Otherwise, the social-networking system may proceed to step 460 and deactivate the activity recommendation. Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for facilitating user engagement in social activities through targeted and private messaging and a double opt-in flow including the particular steps of the method of FIG. 4, this disclosure contemplates any suitable method for facilitating user engagement in social activities through targeted and private messaging and a double opt-in flow including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

### System Overview

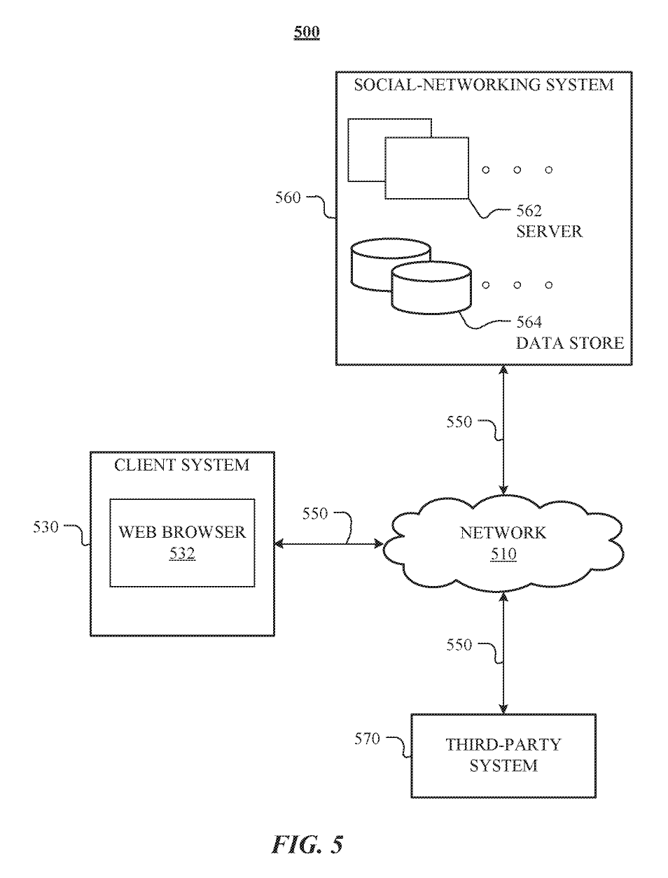

FIG. 5 illustrates an example network environment 500 associated with a social-networking system. Network environment 500 includes a client system 530, a social-networking system 560, and a third-party system 570 connected to each other by a network 510. Although FIG. 5 illustrates a particular arrangement of client system 530, social-networking system 560, third-party system 570, and network 510, this disclosure contemplates any suitable arrangement of client system 530, social-networking system 560, third-party system 570, and network 510. As an example and not by way of limitation, two or more of client system 530, social-networking system 560, and third-party system 570 may be connected to each other directly, bypassing network 510. As another example, two or more of client system 530, social-networking system 560, and third-party system 570 may be physically or logically co-located with each other in whole or in part. Moreover, although FIG. 5 illustrates a particular number of client systems 530, social-networking systems 560, third-party systems 570, and networks 510, this disclosure contemplates any suitable number of client systems 530, social-networking systems 560, third-party systems 570, and networks 510. As an example and not by way of limitation, network environment 500 may include multiple client system 530, social-networking systems 560, third-party systems 570, and networks 510.

This disclosure contemplates any suitable network 510. As an example and not by way of limitation, one or more portions of network 510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 510 may include one or more networks 510.

Links 550 may connect client system 530, social-networking system 560, and third-party system 570 to communication network 510 or to each other. This disclosure contemplates any suitable links 550. In particular embodiments, one or more links 550 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 550, or a combination of two or more such links 550. Links 550 need not necessarily be the same throughout network environment 500. One or more first links 550 may differ in one or more respects from one or more second links 550.

In particular embodiments, client system 530 may be an electronic device including hardware, software, or embedded logic components or a combination of two or more such components and capable of carrying out the appropriate functionalities implemented or supported by client system 530. As an example and not by way of limitation, a client system 530 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 530. A client system 530 may enable a network user at client system 530 to access network 510. A client system 530 may enable its user to communicate with other users at other client systems 530.

In particular embodiments, client system 530 may include a web browser 532, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 530 may enter a Uniform Resource Locator (URL) or other address directing the web browser 532 to a particular server (such as server 562, or a server associated with a third-party system 570), and the web browser 532 may generate a Hyper Text Transfer Protocol (HTTP) request and communicate the HTTP request to server. The server may accept the HTTP request and communicate to client system 530 one or more Hyper Text Markup Language (HTML) files responsive to the HTTP request. Client system 530 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 560 may be a network-addressable computing system that can host an online social network. Social-networking system 560 may generate, store, receive, and send social-networking data, such as, for example, user-profile data, concept-profile data, social-graph information, or other suitable data related to the online social network. Social-networking system 560 may be accessed by the other components of network environment 500 either directly or via network 510. As an example and not by way of limitation, client system 530 may access social-networking system 560 using a web browser 532, or a native application associated with social-networking system 560 (e.g., a mobile social-networking application, a messaging application, another suitable application, or any combination thereof) either directly or via network 510. In particular embodiments, social-networking system 560 may include one or more servers 562. Each server 562 may be a unitary server or a distributed server spanning multiple computers or multiple datacenters. Servers 562 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 562 may include hardware, software, or embedded logic components or a combination of two or more such components for carrying out the appropriate functionalities implemented or supported by server 562. In particular embodiments, social-networking system 560 may include one or more data stores 564. Data stores 564 may be used to store various types of information. In particular embodiments, the information stored in data stores 564 may be organized according to specific data structures. In particular embodiments, each data store 564 may be a relational, columnar, correlation, or other suitable database. Although this disclosure describes or illustrates particular types of databases, this disclosure contemplates any suitable types of databases. Particular embodiments may provide interfaces that enable a client system 530, a social-networking system 560, or a third-party system 570 to manage, retrieve, modify, add, or delete, the information stored in data store 564.

In particular embodiments, social-networking system 560 may store one or more social graphs in one or more data stores 564. In particular embodiments, a social graph may include multiple nodes—which may include multiple user nodes (each corresponding to a particular user) or multiple concept nodes (each corresponding to a particular concept)—and multiple edges connecting the nodes. Social-networking system 560 may provide users of the online social network the ability to communicate and interact with other users. In particular embodiments, users may join the online social network via social-networking system 560 and then add connections (e.g., relationships) to a number of other users of social-networking system 560 to whom they want to be connected. Herein, the term “friend” may refer to any other user of social-networking system 560 with whom a user has formed a connection, association, or relationship via social-networking system 560.

In particular embodiments, social-networking system 560 may provide users with the ability to take actions on various types of items or objects, supported by social-networking system 560. As an example and not by way of limitation, the items and objects may include groups or social networks to which users of social-networking system 560 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 560 or by an external system of third-party system 570, which is separate from social-networking system 560 and coupled to social-networking system 560 via a network 510.

In particular embodiments, social-networking system 560 may be capable of linking a variety of entities. As an example and not by way of limitation, social-networking system 560 may enable users to interact with each other as well as receive content from third-party systems 570 or other entities, or to allow users to interact with these entities through an application programming interfaces (API) or other communication channels.

In particular embodiments, a third-party system 570 may include one or more types of servers, one or more data stores, one or more interfaces, including but not limited to APIs, one or more web services, one or more content sources, one or more networks, or any other suitable components, e.g., that servers may communicate with. A third-party system 570 may be operated by a different entity from an entity operating social-networking system 560. In particular embodiments, however, social-networking system 560 and third-party systems 570 may operate in conjunction with each other to provide social-networking services to users of social-networking system 560 or third-party systems 570. In this sense, social-networking system 560 may provide a platform, or backbone, which other systems, such as third-party systems 570, may use to provide social-networking services and functionality to users across the Internet.

In particular embodiments, a third-party system 570 may include a third-party content object provider. A third-party content object provider may include one or more sources of content objects, which may be communicated to a client system 530. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 560 also includes user-generated content objects, which may enhance a user's interactions with social-networking system 560. User-generated content may include anything a user can add, upload, send, or “post” to social-networking system 560. As an example and not by way of limitation, a user communicates posts to social-networking system 560 from a client system 530. Posts may include data such as status updates or other textual data, location information, photos, videos, links, music or other similar data or media. Content may also be added to social-networking system 560 by a third-party through a “communication channel,” such as a newsfeed or stream.

In particular embodiments, social-networking system 560 may include a variety of servers, sub-systems, programs, modules, logs, and data stores. In particular embodiments, social-networking system 560 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 560 may also include suitable components such as network interfaces, security mechanisms, load balancers, failover servers, management-and-network-operations consoles, other suitable components, or any suitable combination thereof. In particular embodiments, social-networking system 560 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 560 to one or more client systems 530 or one or more third-party system 570 via network 510. The web server may include a mail server or other messaging functionality for receiving and routing messages between social-networking system 560 and one or more client systems 530. An API-request server may allow a third-party system 570 to access information from social-networking system 560 by calling one or more APIs. An action logger may be used to receive communications from a web server about a user's actions on or off social-networking system 560. In conjunction with the action log, a third-party-content-object log may be maintained of user exposures to third-party-content objects. A notification controller may provide information regarding content objects to a client system 530. Information may be pushed to a client system 530 as notifications, or information may be pulled from client system 530 responsive to a request received from client system 530. Authorization servers may be used to enforce one or more privacy settings of the users of social-networking system 560. A privacy setting of a user determines how particular information associated with a user can be shared. The authorization server may allow users to opt in to or opt out of having their actions logged by social-networking system 560 or shared with other systems (e.g., third-party system 570), such as, for example, by setting appropriate privacy settings. Third-party-content-object stores may be used to store content objects received from third parties, such as a third-party system 570. Location stores may be used for storing location information received from client systems 530 associated with users. Advertisement-pricing modules may combine social information, the current time, location information, or other suitable information to provide relevant advertisements, in the form of notifications, to a user.

### Social Graphs

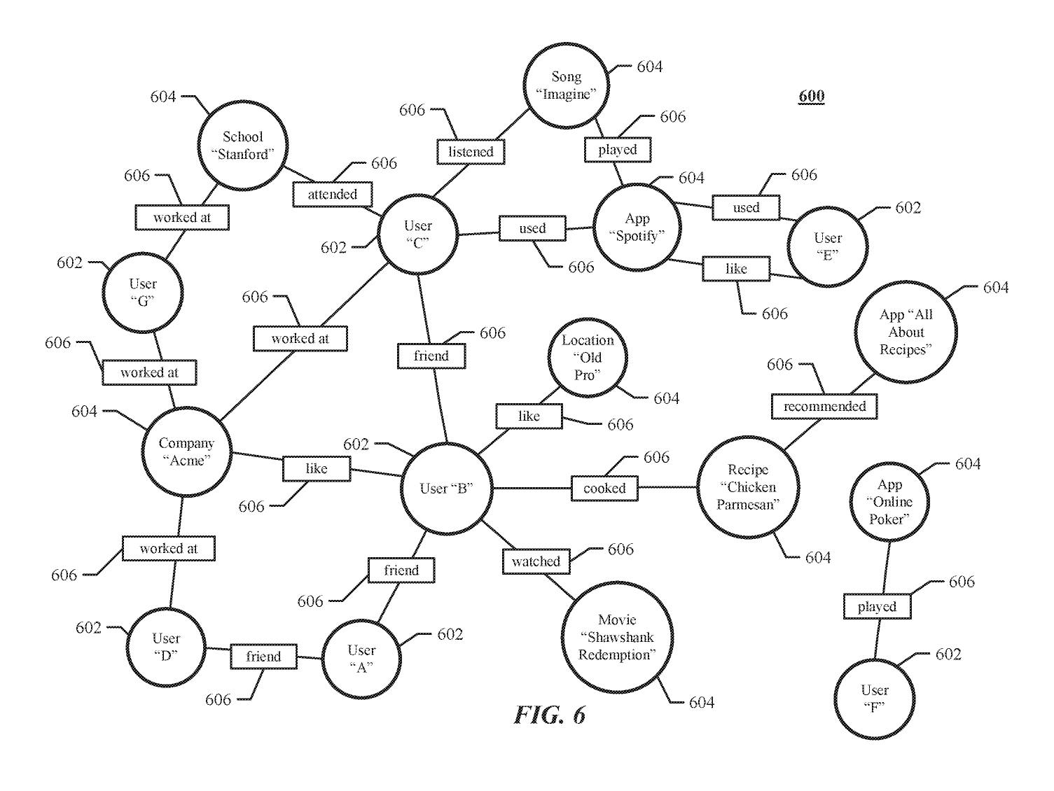

FIG. 6 illustrates example social graph 600. In particular embodiments, social-networking system 560 may store one or more social graphs 600 in one or more data stores. In particular embodiments, social graph 600 may include multiple nodes—which may include multiple user nodes 602 or multiple concept nodes 604—and multiple edges 606 connecting the nodes. Example social graph 600 illustrated in FIG. 6 is shown, for didactic purposes, in a two-dimensional visual map representation. In particular embodiments, a social-networking system 560, client system 530, or third-party system 570 may access social graph 600 and related social-graph information for suitable applications. The nodes and edges of social graph 600 may be stored as data objects, for example, in a data store (such as a social-graph database). Such a data store may include one or more searchable or queryable indexes of nodes or edges of social graph 600.

In particular embodiments, a user node 602 may correspond to a user of social-networking system 560. As an example and not by way of limitation, a user may be an individual (human user), an entity (e.g., an enterprise, business, or third-party application), or a group (e.g., of individuals or entities) that interacts or communicates with or over social-networking system 560. In particular embodiments, when a user registers for an account with social-networking system 560, social-networking system 560 may create a user node 602 corresponding to the user, and store the user node 602 in one or more data stores. Users and user nodes 602 described herein may, where appropriate, refer to registered users and user nodes 602 associated with registered users. In addition or as an alternative, users and user nodes 602 described herein may, where appropriate, refer to users that have not registered with social-networking system 560. In particular embodiments, a user node 602 may be associated with information provided by a user or information gathered by various systems, including social-networking system 560. As an example and not by way of limitation, a user may provide his or her name, profile picture, contact information, birth date, sex, marital status, family status, employment, education background, preferences, interests, or other demographic information. In particular embodiments, a user node 602 may be associated with one or more data objects corresponding to information associated with a user. In particular embodiments, a user node 602 may correspond to one or more webpages.

In particular embodiments, a concept node 604 may correspond to a concept. As an example and not by way of limitation, a concept may correspond to a place (such as, for example, a movie theater, restaurant, landmark, or city); a website (such as, for example, a website associated with social-network system 560 or a third-party website associated with a web-application server); an entity (such as, for example, a person, business, group, sports team, or celebrity); a resource (such as, for example, an audio file, video file, digital photo, text file, structured document, or application) which may be located within social-networking system 560 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 604 may be associated with information of a concept provided by a user or information gathered by various systems, including social-networking system 560. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 604 may be associated with one or more data objects corresponding to information associated with concept node 604. In particular embodiments, a concept node 604 may correspond to one or more webpages.

In particular embodiments, a node in social graph 600 may represent or be represented by a webpage (which may be referred to as a “profile page”). Profile pages may be hosted by or accessible to social-networking system 560. Profile pages may also be hosted on third-party websites associated with a third-party system 570. As an example and not by way of limitation, a profile page corresponding to a particular external webpage may be the particular external webpage and the profile page may correspond to a particular concept node 604. Profile pages may be viewable by all or a selected subset of other users. As an example and not by way of limitation, a user node 602 may have a corresponding user-profile page in which the corresponding user may add content, make declarations, or otherwise express himself or herself. As another example and not by way of limitation, a concept node 604 may have a corresponding concept-profile page in which one or more users may add content, make declarations, or express themselves, particularly in relation to the concept corresponding to concept node 604.

In particular embodiments, a concept node 604 may represent a third-party webpage or resource hosted by a third-party system 570. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 530 to send to social-networking system 560 a message indicating the user's action. In response to the message, social-networking system 560 may create an edge (e.g., a check-in-type edge) between a user node 602 corresponding to the user and a concept node 604 corresponding to the third-party webpage or resource and store edge 606 in one or more data stores.

In particular embodiments, a pair of nodes in social graph 600 may be connected to each other by one or more edges 606. An edge 606 connecting a pair of nodes may represent a relationship between the pair of nodes. In particular embodiments, an edge 606 may include or represent one or more data objects or attributes corresponding to the relationship between a pair of nodes. As an example and not by way of limitation, a first user may indicate that a second user is a “friend” of the first user. In response to this indication, social-networking system 560 may send a “friend request” to the second user. If the second user confirms the “friend request,” social-networking system 560 may create an edge 606 connecting the first user's user node 602 to the second user's user node 602 in social graph 600 and store edge 606 as social-graph information in one or more of data stores 564. In the example of FIG. 6, social graph 600 includes an edge 606 indicating a friend relation between user nodes 602 of user “A” and user “B” and an edge indicating a friend relation between user nodes 602 of user “C” and user “B.” Although this disclosure describes or illustrates particular edges 606 with particular attributes connecting particular user nodes 602, this disclosure contemplates any suitable edges 606 with any suitable attributes connecting user nodes 602. As an example and not by way of limitation, an edge 606 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 600 by one or more edges 606.

In particular embodiments, an edge 606 between a user node 602 and a concept node 604 may represent a particular action or activity performed by a user associated with user node 602 toward a concept associated with a concept node 604. As an example and not by way of limitation, as illustrated in FIG. 6, a user may “like,” “attended,” “played,” “listened,” “cooked,” “worked at,” or “watched” a concept, each of which may correspond to an edge type or subtype. A concept-profile page corresponding to a concept node 604 may include, for example, a selectable “check in” icon (such as, for example, a clickable “check in” icon) or a selectable “add to favorites” icon. Similarly, after a user clicks these icons, social-networking system 560 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 560 may create a “listened” edge 606 and a “used” edge (as illustrated in FIG. 6) between user nodes 602 corresponding to the user and concept nodes 604 corresponding to the song and application to indicate that the user listened to the song and used the application. Moreover, social-networking system 560 may create a “played” edge 606 (as illustrated in FIG. 6) between concept nodes 604 corresponding to the song and the application to indicate that the particular song was played by the particular application. In this case, “played” edge 606 corresponds to an action performed by an external application (SPOTIFY) on an external audio file (the song “Imagine”). Although this disclosure describes particular edges 606 with particular attributes connecting user nodes 602 and concept nodes 604, this disclosure contemplates any suitable edges 606 with any suitable attributes connecting user nodes 602 and concept nodes 604. Moreover, although this disclosure describes edges between a user node 602 and a concept node 604 representing a single relationship, this disclosure contemplates edges between a user node 602 and a concept node 604 representing one or more relationships. As an example and not by way of limitation, an edge 606 may represent both that a user likes and has used at a particular concept. Alternatively, another edge 606 may represent each type of relationship (or multiples of a single relationship) between a user node 602 and a concept node 604 (as illustrated in FIG. 6 between user node 602 for user “E” and concept node 604 for “SPOTIFY”).

In particular embodiments, social-networking system 560 may create an edge 606 between a user node 602 and a concept node 604 in social graph 600. As an example and not by way of limitation, a user viewing a concept-profile page (such as, for example, by using a web browser or a special-purpose application hosted by the user's client system 530) may indicate that he or she likes the concept represented by the concept node 604 by clicking or selecting a “Like” icon, which may cause the user's client system 530 to send to social-networking system 560 a message indicating the user's liking of the concept associated with the concept-profile page. In response to the message, social-networking system 560 may create an edge 606 between user node 602 associated with the user and concept node 604, as illustrated by “like” edge 606 between the user and concept node 604. In particular embodiments, social-networking system 560 may store an edge 606 in one or more data stores. In particular embodiments, an edge 606 may be automatically formed by social-networking system 560 in response to a particular user action. As an example and not by way of limitation, if a first user uploads a picture, watches a movie, or listens to a song, an edge 606 may be formed between user node 602 corresponding to the first user and concept nodes 604 corresponding to those concepts. Although this disclosure describes forming particular edges 606 in particular manners, this disclosure contemplates forming any suitable edges 606 in any suitable manner.

### Social Graph Affinity and Coefficient

In particular embodiments, social-networking system 560 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 570 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 560 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 560 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 560 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 560 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 560 may calculate a coefficient based on a user's actions. Social-networking system 560 may monitor such actions on the online social network, on a third-party system 570, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 560 may calculate a coefficient based on the user's actions with particular types of content. The content may be associated with the online social network, a third-party system 570, or another suitable system. The content may include users, profile pages, posts, news stories, headlines, instant messages, chat room conversations, emails, advertisements, pictures, video, music, other suitable objects, or any combination thereof. Social-networking system 560 may analyze a user's actions to determine whether one or more of the actions indicate an affinity for subject matter, content, other users, and so forth. As an example and not by way of limitation, if a user frequently posts content related to “coffee” or variants thereof, social-networking system 560 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 560 may calculate a coefficient based on the type of relationship between particular objects. Referencing the social graph 600, social-networking system 560 may analyze the number and/or type of edges 606 connecting particular user nodes 602 and concept nodes 604 when calculating a coefficient. As an example and not by way of limitation, user nodes 602 that are connected by a spouse-type edge (representing that the two users are married) may be assigned a higher coefficient than a user nodes 602 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 560 may determine that the user has a higher coefficient with respect to the first photo than the second photo because having a tagged-in-type relationship with content may be assigned a higher weight and/or rating than having a like-type relationship with content. In particular embodiments, social-networking system 560 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 560 may determine that the first user should also have a relatively high coefficient for the particular object. In particular embodiments, the coefficient may be based on the degree of separation between particular objects. The degree of separation between two objects represented by two nodes, respectively, is a count of edges in a shortest path connecting the two nodes in the social graph 600. As an example and not by way of limitation, in the social graph 600, the user node 602 of user “C” is connected to the user node 602 of user “A” via multiple paths including, for example, a first path directly passing through the user node 602 of user “B,” a second path passing through the concept node 604 of company “Acme” and the user node 602 of user “D,” and a third path passing through the user nodes 602 and concept nodes 604 representing school “Stanford,” user “G,” company “Acme,” and user “D.” User “C” and user “A” have a degree of separation of two because the shortest path connecting their corresponding nodes (i.e., the first path) includes two edges 606. The lower coefficient may represent the decreasing likelihood that the first user will share an interest in content objects of the user that is indirectly connected to the first user in the social graph 600. As an example and not by way of limitation, social-graph entities that are closer in the social graph 600 (i.e., fewer degrees of separation) may have a higher coefficient than entities that are further apart in the social graph 600.

In particular embodiments, social-networking system 560 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 530 of the user). A first user may be more interested in other users or concepts that are closer to the first user. As an example and not by way of limitation, if a user is one mile from an airport and two miles from a gas station, social-networking system 560 may determine that the user has a higher coefficient for the airport than the gas station based on the proximity of the airport to the user.

In particular embodiments, social-networking system 560 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 560 may provide information that is relevant to user's interests and current circumstances, increasing the likelihood that they will find such information of interest. In particular embodiments, social-networking system 560 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 560 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 560 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 570 (e.g., via an API or other communication channel), or from another suitable system. In response to the request, social-networking system 560 may calculate the coefficient (or access the coefficient information if it has previously been calculated and stored). In particular embodiments, social-networking system 560 may measure an affinity with respect to a particular process. Different processes (both internal and external to the online social network) may request a coefficient for a particular object or set of objects. Social-networking system 560 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503093, filed 11 Aug. 2006, U.S. patent application Ser. No. 12/977027, filed 22 Dec. 2010, U.S. p;atent application Ser. No. 12/978265, filed 23 Dec. 2010, and U.S. patent application Ser. No. 13/632869, filed 1 Oct. 2012, each of which is incorporated by reference.

### Privacy

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 604 corresponding to a particular photo may have a privacy setting specifying that the photo may only be accessed by users tagged in the photo and their friends. In particular embodiments, privacy settings may allow users to opt in or opt out of having their actions logged by social-networking system 560 or shared with other systems (e.g., third-party system 570). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 570, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 562 may be authorization/privacy servers for enforcing privacy settings. In response to a request from a user (or other entity) for a particular object stored in a data store 564, social-networking system 560 may send a request to the data store 564 for the object. The request may identify the user associated with the request and may only be sent to the user (or a client system 530 of the user) if the authorization server determines that the user is authorized to access the object based on the privacy settings associated with the object. If the requesting user is not authorized to access the object, the authorization server may prevent the requested object from being retrieved from the data store 564, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

### Systems and Methods

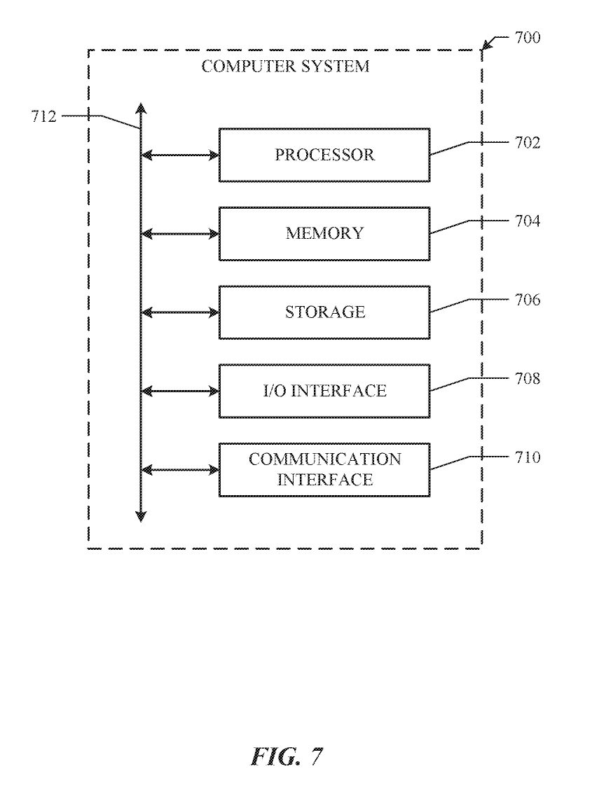

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems of an online social network:
identifying, by the one or more computing systems, a plurality of users of the online social network based on one or more affinity coefficients between the users and a geographical location associated with each of the users;
sending, by the one or more computing systems, a message corresponding to an activity recommendation to each of the users, wherein the message comprises:
identification information of one or more of the other users of the plurality of users, and
a prompt for a response from the receiving user indicating whether the receiving user is interested in the recommended activity;
receiving, by the one or more computing systems, one or more responses to the message from one or more users of the plurality of users, respectively, wherein each response indicates whether the respective user is interested in the recommended activity; and
responsive to receiving the one or more responses, by the one or more computing systems:
if the response from each of at least two of the users indicates an interest in the recommended activity, then sending a notification to each of the users who indicated an interest in the recommended activity identifying the other users who also indicated an interest in the recommended activity,
else, deactivating the activity recommendation.

2. The method of claim 1, wherein identifying the plurality of users is based at least in part on proximity among one or more of the geographical locations associated with one or more of the users, respectively.

3. The method of claim 1, wherein each of the identified users is within a particular degree of separation within a social graph of the online social network from each of the other identified users.

4. The method of claim 1, wherein the affinity coefficient between a given pair of users is based at least in part on one or more of:
a degree of separation between the users in a social graph of the online social network;
a commonality between the users;
a social-interaction history between the users; or
demographic information of the users.

5. The method of claim 1, wherein identifying the plurality of users is further based on one or more selection rules.

6. The method of claim 5, wherein at least one of the selection rules specifies that identifying one or more of the users is based on a condition that the one or more of the users are not identified for a different activity recommendation within a specified time period.

7. The method of claim 1, wherein the message comprises one or more of:
a time period associated with the activity recommendation;
a geographical location associated with the activity recommendation; or
a description of the recommended activity.

8. The method of claim 1, wherein the activity recommendation is generated based on a common interest associated with one or more of the identified users, the common interest being determined based on one or more user profiles associated with the one or more of the identified users, respectively.

9. The method of claim 1, further comprising:
accessing a social graph comprising a plurality of nodes and a plurality of edges connecting the nodes, each of the edges between two of the nodes representing a single degree of separation between them, the nodes comprising:
a plurality of first nodes corresponding to the plurality of users; and
a plurality of second nodes corresponding to a plurality of objects associated with the online social network, respectively;
wherein the message further comprises a reference to an object of the plurality of objects, the object being associated with the activity recommendation, wherein the second node corresponding to the referenced object is connected to one or more of the first nodes by one or more of the edges, respectively.

10. The method of claim 1, wherein sending the message is performed as part of an activity-recommendation process of the online social network, wherein the activity-recommendation process sends messages corresponding to activity recommendations at a pre-determined frequency.

11. The method of claim 1, wherein the activity recommendation is associated with an expiry date, and wherein the method further comprises deactivating the activity recommendation when the expiry date has passed.

12. The method of claim 1, wherein sending the notification comprises initiating a message thread including each of the users who indicated an interest in the recommended activity.

13. The method of claim 1, wherein if the response from each of at least two of the users indicates an interest in the recommended activity, then the method further comprises:
identifying one or more additional users of the online social network, wherein the additional users are identified based on social-networking information associated with the at least two of the users;
sending the message corresponding to the activity recommendation to each of the additional users;
receiving one or more responses to the message from one or more users of the additional users, respectively, wherein each response indicates that the respective additional user is interested in the recommended activity; and
sending an additional notification to each of the users who indicated an interest in the recommended activity identifying the other users who also indicated an interest in the recommended activity.

14. The method of claim 1, further comprising:
generating the activity recommendation based on one or more of:
one or more prior activities associated with one or more users of the plurality of users;
one or more responses to one or more prior messages corresponding to activity recommendations received from one or more users of the plurality of users; or
one or more upcoming events associated with one or more users of the plurality of users.

15. The method of claim 1, further comprising, for a first user of the plurality of users:
recording one or more responses by the first user to one or more prior messages corresponding to activity recommendations;
identifying one or more second users identified in the prior messages; and
compiling a list of users of interest to the first user, the list comprising one or more of the second users.

16. The method of claim 1, wherein the plurality of users comprise:
a first user; and
one or more second users identified in a list of users of interest to the first user received from the first user.

17. The method of claim 1, further comprising, for each user of the plurality of users:
accessing one or more privacy settings associated with the user; and
determining, based on the privacy settings and prior to sending the message, that the geographical location of the user is visible to each of the other users of the plurality of users.

18. The method of claim 1, further comprising, for each user of the plurality of users:
accessing one or more privacy settings associated with the user; and
verifying, based on the privacy settings and prior to sending the message, that information associated with the user in the message is visible to each of the other users of the plurality of users.

19. One or more computer-readable non-transitory storage media embodying software that is operable when executed to:
identify a plurality of users of an online social network based on one or more affinity coefficients between the users and a geographical location associated with each of the users;
send a message corresponding to an activity recommendation to each of the users, wherein the message comprises:
identification information of one or more of the other users of the plurality of users, and
a prompt for a response from the receiving user indicating whether the receiving user is interested in the recommended activity;
receive one or more responses to the message from one or more users of the plurality of users, respectively, wherein each response indicates whether the corresponding user is interested in the recommended activity; and
responsive to receiving the one or more responses:
if the response from each of at least two of the users indicates an interest in the recommended activity, then send a notification to each of the users who indicated an interest in the recommended activity identifying the other users who also indicated an interest in the recommended activity,
else, deactivate the activity recommendation.

20. A system comprising: one or more processors; and one or more computer-readable non-transitory storage media coupled to one or more of the processors and comprising instructions operable when executed by one or more of the processors to cause the system to:
identify a plurality of users of an online social network based on one or more affinity coefficients between the users and a geographical location associated with each of the users;
send a message corresponding to an activity recommendation to each of the users, wherein the message comprises:
identification information of one or more of the other users of the plurality of users, and
a prompt for a response from the receiving user indicating whether the receiving user is interested in the recommended activity;
receive one or more responses to the message from one or more users of the plurality of users, respectively, wherein each response indicates whether the corresponding user is interested in the recommended activity; and
responsive to receiving the one or more responses:
if the response from each of at least two of the users indicates an interest in the recommended activity, then send a notification to each of the users who indicated an interest in the recommended activity identifying the other users who also indicated an interest in the recommended activity,
else, deactivate the activity recommendation.
